(19) United States
(12) Patent Application Publication
(10) Pub. No.: US 2014/0000479 A1
(43) Pub. Date: Jan. 2, 2014

(54) Bituminious Compositions and Methods for Reducing Toxic Emissions From Bituminious Compositions.

(71) Applicants: Jim Stevens, Astoria, OR (US); Bart Lungren, Worland, WY (US)

(72) Inventors: Jim Stevens, Astoria, OR (US); Bart Lungren, Worland, WY (US)

(21) Appl. No.: 13/875,081

(22) Filed: May 1, 2013

(51) Int. Cl. C08L 95/00

(52) U.S. Cl. CPC C08L 95/00
USPC 106/273.1

(57) ABSTRACT

Methods of reducing toxic emissions from coal tar or asphalt compositions. The methods include providing an initial composition including coal tar, a coal tar emulsion, or asphalt and adding a rheological modifier to the initial composition to form a reduced emission composition, wherein the rheological modifier includes a tall oil saponified in an anhydrous strong base and wherein the reduced emission composition releases less toxic emissions into the atmosphere than the initial composition itself would otherwise release. Further, reduced emission compositions for reducing toxic emissions that would otherwise occur in coal tar compositions or asphalt compositions. The reduced emission compositions include an initial composition including coal tar, a coal tar emulsion, or asphalt; and a chemical rheological modifier including a tall oil saponified in an anhydrous strong base.

### BACKGROUND

The present disclosure relates generally to methods for reducing toxic emissions in bituminous compositions and to reduced emission bituminous compositions. In particular, methods for reducing toxic emissions of polycyclic aromatic hydrocarbons (PAHs), volatile organic compounds (VOCs), carcinogens, and carbon compounds from coal tar compositions and asphalt compositions used in paving, paving maintenance, and roofing applications are described.

Bituminous compositions, such as coal tar and asphalt compositions, are in widespread use for a variety of important applications. For example, coal tar compositions, such as coal tar and coal tar emulsions, are utilized in pavement sealing products to protect and beautify the underlying payment. Asphalt compositions (referred to as bitumen in some regions) are commonly used in hot mix paving applications to make asphalt concrete for road surfaces and to repair existing roadways.

Asphalt and coal tar may appear similar and be used for similar application, but they are derived from different raw materials and have different chemistry. Coal tar and asphalt generally are incompatible.

Coal tar is obtained by heating bituminous coal to very high temperatures and collecting the volatile materials that are produced. These volatiles are referred to as crude coke oven tar, and the solid residue left behind is called coke. The crude coke oven tar is processed to recover a variety of materials including creosote and precursors for a large number of other important chemicals. The residue left after this processing step is called coal tar pitch, which comprises primarily aromatic hydrocarbons. The coal tar pitch is the material used in the more familiar applications of roofing and asphalt concrete surface treating.

Asphalt, on the other hand, is derived from petroleum or crude oil and comprises primarily aliphatic hydrocarbons. Crude oil is processed at a refinery by distilling off the “light ends” to produce materials such as propane, gasoline, fuel oils, and chemical intermediates. The residue that remains from the distillation is referred to as straight-run asphalt. Straight run asphalt is processed primarily for road paving applications, and after farther processing (e.g., oxidation or blowing), it is converted to roofing asphalts designated as D312 Types I through IV, by the American Society for Testing and Materials (ASTM)

Various additives and polymers have been utilized for the purpose of improving the high and low temperature characteristics of coal tar and asphalt compositions, as well as to improve their toughness and durability. One limit of the prior art is the relatively small amount of saponified tall oil capable of being kept in solution with asphalt. Another limit of the prior art relates to undesirably high moisture levels introduced to bituminous compositions.

Water is deleterious to molten asphalt blending processes, since the water flashes off at the temperatures involved in the blending process. Water flashing off in the molten asphalt mixture causes the asphalt to swell. The prior art discloses various attempts to produce asphalt blends, or other tall oil containing compositions, utilizing a minimum of added water.

Despite their widespread use and importance to modern society, some have raised concerns about the safety of bituminous compositions to people, animals, and the environment. Coal tar and asphalt compositions are known to emit toxic gasses that cause cancer in humans, irritate the eyes, nose, and throat, cause dizziness and headaches, harm aquatic life, and create smog. The toxic gasses released by coal tar and asphalt compositions include polycyclic aromatic compounds (PAHs) and volatile organic compounds VOCs.

Polycyclic aromatic compounds (PAHs) are also known as poly-aromatic hydrocarbons or polynuclear aromatic hydrocarbons. Polycyclic aromatic compounds are potent atmospheric pollutants that consist of fused aromatic rings and do not contain heteroatoms or carry substituents. Some polycyclic aromatic compounds have been identified as carcinogenic, mutagenic, and teratogenic.

Volatile organic compounds (VOCs) are organic chemicals that have a high vapor pressure at ordinary, room-temperature conditions. VOCs are numerous, varied, and ubiquitous. They include both human-made and naturally occurring, chemical compounds. The United States Environmental Protection Agency (EPA) regulates VOCs in the air, water, and land. The United States Department of Labor and its Occupational Safety and Health Administration (OSHA) regulate VOC exposure in the workplace.

Known methods of utilizing coal tar and asphalt compositions in paving and roofing applications are not entirely satisfactory because they expose workers and the public to undesirably high levels of toxic emissions from the coal tar and asphalt compositions. The toxic emission problem is exacerbated by the need to heat the coal tar and asphalt compositions to elevated temperatures, which increases the rate of toxic gas emissions, to use them in paving applications. There is a current risk that regulations or commercial practice will limit or prevent the use of coal tar and/or asphalt compositions in paving applications to address health concerns resulting from toxic emissions.

Thus, there exists a need for methods for reducing toxic emissions in bituminous compositions that improve upon and advance the design of known methods for utilizing coal tar and asphalt compositions. Further, there exists a need for reduced emission bituminous compositions that improve upon known coal tar and asphalt compositions. Examples of new and useful methods and compositions relevant to the needs existing the field are discussed below.

Disclosure addressing one or more of the identified existing needs is provided in the detailed description below. Examples of references relevant to coal tar and asphalt methods and compositions include U.S. Pat. Nos. 1,813,454, 2,268,122, 2,753,363 4,129,520, 4,450,011, 4,806,166, 4,859,245, 4,874,432, 5,221,703, and 5,496,400. The complete disclosures of the above patents and patent applications are herein incorporated by reference for all purposes.

U.S. Pat. No. 5,221,703, entitled Engineered Modified Asphalt Cement, relates to a modified bituminous material containing asphalt tall oil, a polymer, such as styrene butadiene, natural latex, etc., and a strong base, preferably sodium hydroxide or potassium hydroxide. A small amount of water is present in the composition, either as water in a solution of the strong base, or water in a latex added as the polymer the composition.

U.S. Pat. No. 1,813,454, entitled Saponification, discloses a process for saponifying organic esters, particularly the esters of fatty acids, such as vegetable and animal fats. The process comprises treating the organic ester with substantially anhydrous alkali in the presence of an inert organic diluent in which the alcoholic component of the ester is substantially insoluble, and simultaneously removing the alcoholic component in a concentrated form by partial pressure distillation of the diluent and the alcoholic component.

U.S. Pat. No. 2,268,122, entitled Road Tars or the Like and the Methods of Making Them, also discloses a process for substantially anhydrous saponification of fatty oils using an organic diluent such as kerosene.

U.S. Pat. No. 2,753,363, entitled Method of Making Soap, relates to the manufacture of soap, and more particularly to an improved method of making a soap of relatively low moisture content wherein the saponification is carried out in stages. In the first stage, a fatty acid mixture, or a mixture of fatty acids and glycerides, is reacted with a quantity of dry alkali metal carbonate that is sufficient to saponify a substantial proportion of the tree fatty acids present in the raw material but insufficient to saponify all of the fatty materials present. Thereafter, in a second stage, saponification of the fatty material is completed with a concentrated aqueous caustic alkali.

U.S. Pat. No. 4,129,520, entitled Soap Making, discloses a process for saponifying organic acid esters in fats from animal or vegetable sources. In the '520 process, the organic acid esters are saponified with alkali metal hydroxide in a liquid reaction medium comprising a substantially water-free alkyl nitrile. The preferred anhydrous reaction media are acetonitrile and proprionitrile. The stated advantage of the anhydrous preparation method is that the solvent removal is less energy intensive than in aqueous processes. The preferred products of the process are soaps and detergents.

U.S. Pat. No. 4,874,432, entitled Multigrade Asphalt Cement Product and Process, relates to a process for producing a multi-grade asphalt cement product. The process involves saponifying in liquefied asphalt, substantially free of water, at least one fatty acid and at leas one resin acid with an alkali metal base, or by adding the already saponified acid to the liquefied asphalt. The resulting gelled asphalt cement is utilized in conventional processes for road paving, roofing, and specialty applications. The preferred organic acid component for the process is tall oil and the preferred alkali metal base is anhydrous sodium hydroxide.

### SUMMARY

The present disclosure is directed to methods of reducing toxic emissions from coal tar or asphalt compositions. The methods include providing an initial composition including coal tar, a coal tar emulsion, or asphalt and adding a rheological modifier to the initial composition to form a reduced emission composition, wherein the rheological modifier includes a tall oil saponified in an anhydrous strong base and wherein the reduced emission composition releases less toxic emissions into the atmosphere than the initial composition itself would otherwise release.

The present disclosure is further directed to reduced emission compositions tot reducing toxic emissions that would otherwise occur in coal tar compositions or asphalt compositions. The reduced emission compositions include an initial composition including coal tar, a coal tar emulsion, or asphalt; and a chemical rheological modifier including a tall oil saponified in an anhydrous strong base.

### BRIEF DESCRIPTION OF THE DRAWINGS

FIG. 1 is flow diagram of a first method for reducing emissions from bituminous compositions.

FIG. 2 is flow diagram of a second method for reducing emissions from bituminous compositions.

### DETAILED DESCRIPTION

The disclosed methods and compositions will become better understood through review of the, following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations; however, for the sake of brevity; each and every contemplated variation is not individually described in the following detailed description.

Throughout the following detailed description, examples of various methods and compositions are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

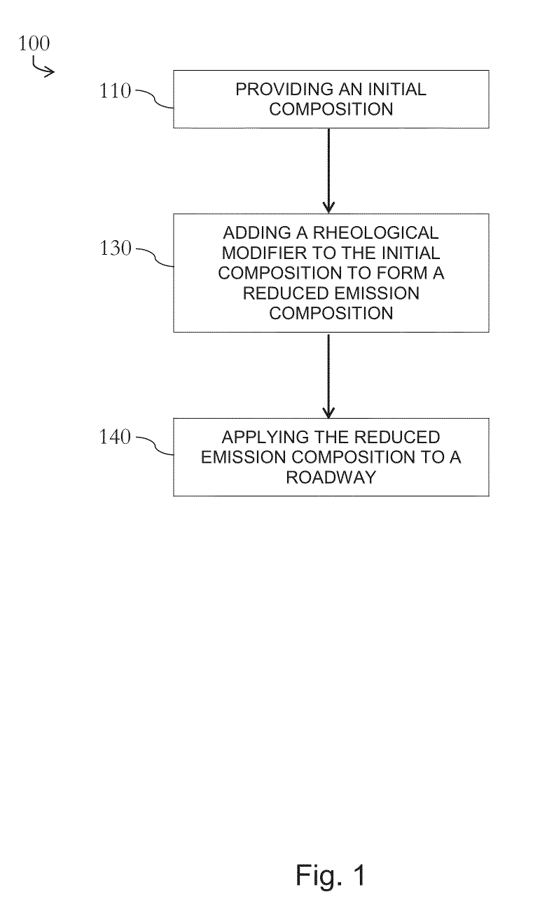

With reference to FIG. 1, a first example of a method 100 for reducing toxic emissions from bituminous compositions will now be described. Expressed another way, method 100 forms a reduced emission bituminous composition from an initial bituminous composition, where the reduced emission bituminous composition releases less toxic emissions into the atmosphere than the initial bituminous composition itself would otherwise release.

Method 100 helps to reduce people's exposure to toxic emissions released from bituminous compositions, such as coal tar and asphalt compositions. Reducing toxic emissions provides numerous health, safety, comfort, and economic benefits to those working with, exposed to, and/or seeking to deploy bituminous compositions, Further, method 100 enables coal tar and asphalt compositions to be used with less impact on the environment by reducing the amount of environmentally harmful compounds, such as VOCs, greenhouse gasses, and carbon compounds, released to the atmosphere.

Toxic emissions reduced by method 100 include known and suspected carcinogens, such as polycyclic aromatic compounds (PAHs) and volatile organic compounds (VOCs). Further, method 100 enables coal tar and asphalt compositions to be used with less impact on the environment by reducing the amount of environmentally harmful compounds, such as (VOCs), carbon compounds, and greenhouse gases, released to the atmosphere. In some examples, method 100 reduces toxic emissions by 15 percent or more relative to the toxic emissions released by bituminous compositions not processed by method 100. In other examples, reductions of 69%, 77%, and higher have been observed.

The polycyclic aromatic hydrocarbons reduced by method 100 may include naphthalene, 2-methylinaphthalene, 1-methylinaphthalene, acenaphthylene, or acenaphthene. Additionally or alternatively, the polycyclic aromatic hydrocarbons reduced by method 100 may include fluorine, pyrene, phenanthrene, or phenanthrene.

One particular type of toxic emission reduced by the methods described herein is known as “blue smoke.” Blue smoke is collection of airborne solid and liquid particulates and gases having a bluish color and having adverse health impacts on those who inhale or come in contact with the smoke. The methods described herein have been observed to raise the temperature at which blue smoke begins to emit when bituminous compositions are heated. For example, the methods described herein have been observed to raise the blue smoke onset temperature from approximately 385 degrees Fahrenheit to between 475 and 500 degrees Fahrenheit for crumb rubber material.

By elevating the temperature at which blue smoke begins to emit, it may be possible to work with and use bituminous compositions effectively at temperatures above the standard blue smoke temperature. With the methods described herein, bituminous compositions can be worked and used at customary temperatures, but without the normal onset of blue smoke emission because of the elevated blue smoke temperature provided by the disclosed methods. In effect, the methods described here serve to reduce or eliminate blue smoke emission in the normal course of bituminous composition processing for roadway and roofing applications.

By reducing toxic emissions that adversely affect people's health and the environment, method 100 addresses the concerns of health, safety, and environmental regulators. Addressing the concerns associated with bituminous compositions reduces the risk that regulators will limit or prevent people from using coal tar and asphalt compositions. Providing a ready means to improve the characteristics of coal tar and asphalt compositions, method 100 encourages their use in vital infrastructure, such as roadways, parking lots, and roofs of homes and buildings.

With reference to FIG. 1, method 100 includes providing an initial composition at step 110, adding a rheological modifier to the initial composition to form a reduced emission composition at step 130 and applying the reduced emission composition to a roadway at step 140. Step 140 is optional and serves to highlight one application for the methods described herein; namely, reducing toxic emissions from coal tar and asphalt compositions used for paved surfaces, such as roadway surfaces and parking lot surfaces. The reader should appreciate that the methods described herein serve to reduce toxic emissions in coal tar and asphalt compositions however the resulting reduced emission composition is used thereafter.

The initial composition provided at step 110 includes coal tar, a coal tar emulsion, or asphalt. Those skilled in the art will recognize that asphalt is known as bitumen in some regions. This disclosure refers to asphalt for convenience, but the reader should appreciate that the disclosure equates asphalt and bitumen for purposes of the methods and compositions described herein.

Any currently known or later developed form, type, or blend of bituminous composition may be provided at step 100. For example, a wide variety of coal tar and asphalt compositions are known and the present method is not limited to any one particular variation of such compositions. Suitable coal tar emulsions include emulsions of a coal tar in an aqueous medium with an emulsifying or dispersing agent, such as an organic soap or detergent and/or an inorganic colloid. One suitable example of an inorganic colloid is particulate clay.

With reference to FIG. 1, adding a rheological modifier to the initial composition at step 130 forms a reduced emission composition. The rheological modifier may include a tall oil saponified in an anhydrous strong base. In some examples, the anhydrous strong base is anhydrous sodium hydroxide. In other examples, strong anhydrous bases other than sodium hydroxide, such as potassium hydroxide, are used.

The tall oil may be derived from a variety of trees via known means, such as those described in U.S. Pat. No. 5,496,400, which is incorporated by reference herein for all purposes. The rheological modifier may include both crude and distilled tall oils saponified in a strong, anhydrous base. Suitable methods for saponifying tall oils are described in U.S. Pat. No. 5,496,400.

Adding the rheological modifier at step 130 includes adding an amount of rheological modifier representing about 1 weight percent or more of the weight of the initial composition. In other examples, rheological modifier representing at least 3 weight percent of the weight of the initial composition is added. Adding more rheological modifier has been observed to reduce the toxic emissions released from bituminous compositions to a greater degree. The methods described herein contemplate adding larger proportions of rheological modifier with an awareness that practical considerations and economics may dictate that a balance between the amount of modifier added and the level of toxic emission reduction be reached.

Adding the rheological modifier at step 130 may include heating the initial composition to a selected elevated temperature and adding the rheological modifier to the initial composition once it is heated to the selected elevated temperature. The selected elevated temperature may vary depending on the particular bituminous composition used, i.e., coal tar compositions may optimally receive rheological modifier at an different elevated temperature than used for asphalt compositions or coal tar emulsions.

In some examples, the selected elevated temperature is a temperature that places the bituminous composition into a molten state. In some examples, the selected elevated temperatures is 325 degrees Fahrenheit or greater. In other examples, the elevated temperature is 400 and 500 degrees Fahrenheit.

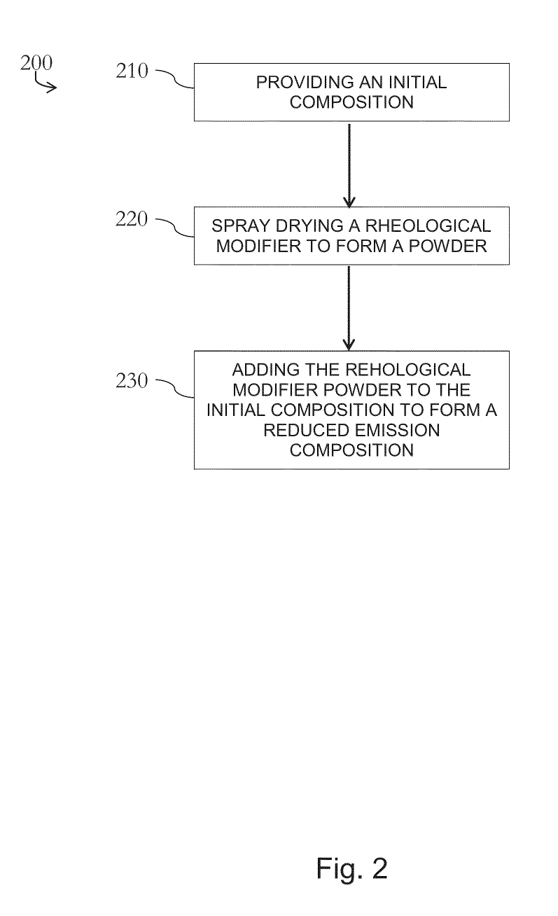

As shown in FIG. 2 at step 220, the rheological modifier may be spray dried to form a powder. Spray drying the rheological modifier at step 220 serves to form a powder with a water content of not snore than 1 weight percent of the weight of the rheological modifier. Reducing the water content of the rheological modifier helps reduce or avoid swelling the bituminous composition when the composition is heated to a molten state from water flashing off inside the bituminous composition.

Applying the reduced emission composition to a roadway as depicted in FIG. 1 may occur by any known or later developed technique for applying bituminous compositions to roadways. For example, applying the reduced emission composition to a roadway may include spraying, pouring, or shoveling, the reduced emission composition onto a roadway. Alternatively to roadway applications, the reduced emission composition may be applied to roots or rooting materials. The reduced emission composition may additionally or alternatively be applied to parking lots, driveways, and garage floors.

Turning attention to FIG. 2, a second example of a method for reducing toxic emissions from bituminous compositions, method 200 will now be described. Method 200 includes many similar or identical features to method 100. Thus, for the sake of brevity, each feature of method 200 will not be redundantly explained. Rather, key distinctions between method 200 and method 100 will be described in detail and the reader should reference the discussion above for features substantially similar between the two methods.

As shown in FIG. 2, method 200 includes providing an initial composition at step 210, spray drying a rheological modifier to form a powder at step 220, and adding the rheological modifier powder to the initial composition to form a reduced emission composition at step 230. A primary distinction between method 200 and method 100 is that method 200 includes spray drying the rheological modifier to form a powder. Spray drying the rheological modifier at step 220 serves to form a powder with a water content of not more than 1 weight percent of the weight of the rheological modifier. Reducing the water content of the rheological modifier helps reduce or avoid swelling the bituminous composition when the composition is heated to a molten state from water flashing off inside the bituminous composition.

In addition to methods for reducing toxic emissions in bituminous compositions, the present disclosure is directed to reduced emission bituminous compositions. Accordingly, a reduced emission bituminous composition will now be described. Reduced emission bituminous compositions serve to reduce toxic emissions that would otherwise occur in conventional bituminous compositions. The reader is directed to the teachings above for technical details related to methods of making and to the constituents of the reduced emission bituminous compositions.

In one example, a reduced emission bituminous composition includes an initial bituminous composition and rheological modifier. The initial bituminous composition includes coal tar, a coal tar emulsion, or asphalt. The chemical rheological modifier includes a tall oil saponified in an anhydrous strong base. The anhydrous strong base may be an anhydrous sodium hydroxide or other strong anhydrous base, such as potassium hydroxide. The saponified tall oil may be distilled or not distilled.

In some examples, the chemical rheological modifier represents about 1 weight percent or more of the weight of the initial composition. The reduced emission bituminous composition may include larger proportions of rheological modifier and larger proportions of modifier have been observed to further reduce toxic emissions. The toxic emissions reduced by the reduced emission bituminous composition may include polycyclic aromatic hydrocarbons (PAHs), volatile organic compounds (VOCs), carcinogens, and carbon compounds, In some examples, the reduced emission bituminous composition emits at least 15 percent less toxic emissions than the initial composition.

Some representative examples of how the methods and compositions described herein have reduced toxic emissions are provided below.

In a first example, coal tar samples, a first collection of samples containing no rheological modifier and a second collection containing three percent rheological modifier, were equilibrated in sealed vials at 250 F for 4 hours. Headspace was collected via vacuum pump and concentrated on 0.45 micron nylon filters. The collected material was eluted using methylene chloride, injected directly into a gas chromatography-mass spectrometer, and analyzed for polynuclear aromatic hydrocarbons (PAHs).

Headspace samples were also collected using a gastight syringe and analyzed for volatile organic compounds (VOCs) via direct injection of 10 uL. Due to saturation of the detector, no quantifiable difference was noted between samples analyzed for VOCs. The table below details the percent reduction of the various toxic compounds tested. As the table below demonstrates, toxic emissions overall were reduced by 15.5%.

TABLE 1
Reduction of Toxic Emissions in Coal Tar Samples with Rheological
Modifier

| | Bituminous | | |
|---|---|---|---|
| | Composition | Bituminous | |
| | with No | Composition | |
| | Rheological | with 3% | |
| | Modifier | Rheological | Percent |
| Compound | Added | Modifier Added | Reduction |
| Naphthalene | 25,276,019 | 19,843,313 | 21.49% |
| 2-Methylinaphthalene | 5,235,557 | 4,554,299 | 13.01% |
| 1-Methylinaphthalene | 2,511,944 | 2,215,234 | 11.81% |
| Acenaphthylene | 19,244 | 19,074 | 0.88% |
| Acenaphthene | 7,281,378 | 6,613,463 | 9.17% |
| Fluorene | 4,574,637 | 4,551,267 | 0.51% |
| Phenanthrene | 6,679,074 | 5,927,972 | 11.25% |
| Anthracene | 2,651,500 | 2,249,438 | 15.16% |
| Fluoranthene | 438,014 | 441,848 | −0.88% |
| Pyrene | 255,918 | 254,842 | 0.42% |
| Benzo (a) anthracene | 25,276,019 | 19,843,313 | 21.49% |
| Totals | 54,923,285 | 46,415,908 | Avg. 15.5% |

In a second example, coal tar emulsion samples, a first collection of samples containing no rheological modifier and a second collection of samples containing one-and-a-half percent rheological modifier, were equilibrated in sealed vials at 450 F for 4 hours. Headspace was collected via vacuum pump and concentrated on 0.45 micron nylon filters. The collected material was dated using methylene chloride injected directly into gas chromatography-mass spectrometer, and analyzed for polynuclear aromatic hydrocarbons (PAHs).

TABLE 2
Reduction of Toxic Emissions in Coal Tar Emulsion Samples with
Rheological Modifier

| | Bituminous | Bituminous | |
|---|---|---|---|
| | Composition | Composition | |
| | with No | with 1.5% | |
| | Rheological | Rheological | Percent |
| Compound | Modifier Added | Modifier Added | Reduction |
| Benzene | 334,579 | 228,619 | 31.67% |
| Toluene | 257,004 | 103,322 | 59.80% |
| Ethylbenzene | 127,209 | 23,893 | 81.22% |
| m,p-Xylene | 55,088 | 9,635 | 82.51% |
| o-Xylene | 13,495 | 1,352 | 89.98% |
| Totals | 787,375 | 366,821 | Avg. 69.04% |

In a third example, asphalt samples, a first collection containing no rheological modifier and a second collection containing two percent rheological modifier, were equilibrated in sealed vials at 450 F for 4 hours. Headspace was collected via vacuum pump and concentrated on 0.45 micron nylon filters. The collected material was eluted using methylene chloride injected directly into gas chromatography-mass spectrometer, and analyzed for polynuclear aromatic hydrocarbons (PAHs).

TABLE 3
Reduction of Toxic Emissions in Asphalt Sample with Rheological
Modifier

| | Bituminous | Bituminous | |
|---|---|---|---|
| | Composition | Composition | |
| | with No | with 2% | |
| | Rheological | Rheological | Percent |
| Compound | Modifier Added | Modifier Added | Reduction |
| Acenaphthene | 2,046 | 1,198 | 41.45% |
| Fluorene | 36,463 | 4,565 | 87.48% |
| Phenanthrene | 339,703 | 34,599 | 89.81% |
| Anthracene | 129,143 | 17,152 | 86.72% |
| Fluoranthene | 43,206 | 9,258 | 78.57% |
| Pyrene | 23,958 | 5,791 | 75.83% |
| Totals | 574,519 | 72,563 | Avg. 76.64% |

In a fourth example, samples of asphalt modified into crumb rubber form were equilibrated in sealed vials at 450 F for 4 hours. A first collection of crumb rubber samples contained no rheological modifier and a second collection of crumb rubber samples contained two percent rheological modifier. Headspace was collected via vacuum pump and concentrated on 0.45 micron nylon filters. The collected material was eluted using methylene chloride injected directly into gas chromatography-mass spectrometer, and analyzed for polynuclear aromatic hydrocarbons (PAHs).

TABLE 4
Reduction of Toxic Emissions in Crumb Rubber Sample with
Rheological Modifier

| | Bituminous | Bituminous | |
|---|---|---|---|
| | Composition | Composition | |
| | with No | with 2% | |
| | Rheological | Rheological | Percent |
| Compound | Modifier Added | Modifier Added | Reduction |
| Naphthalene | 4,123 | 2,461 | 40.31 |
| 2-Methylinaphthalene | 3,125 | 1,893 | 39.42 |
| 1-Methylinaphthalene | 1,623 | 865 | 46.70 |
| Acenaphthene | 2,016 | 922 | 54.27 |
| Fluorene | 13,123 | 7,694 | 41.37 |
| Phenanthrene | 42,431 | 38,340 | 9.64 |
| Anthracene | 11,561 | 11,119 | 3.82 |
| Fluoranthene | 10,679 | 13,563 | −27.01 |
| Pyrene | 21,124 | 27,110 | −28.34 |
| Totals | 109,805 | 103,967 | Avg. |
| | | | 20.02% |

The disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and non-obvious combinations and subcombinations of the various elements, features, functions and/or properties disclosed above and inherent to those skilled in the art pertaining to such inventions. Where the disclosure or subsequently filed claims recite “a” element, “a first” element, or any such equivalent term, the disclosure or claims should be understood to incorporate one or more such elements, neither requiring nor excluding two or more such elements.

Applicant(s) reserves the right to submit claims directed to combinations and subcombinations of the disclosed inventions that are believed to be novel and non-obvious. Inventions embodied in other combinations and subcombinations of features, functions, elements and/or properties may be claimed through amendment of those claims or presentation of new claims in the present application or in a related application. Such amended or new claims, whether they are directed to the same invention or a different invention and whether they are different, broader, narrower or equal in scope to the original claims, are to be considered within the subject matter of the inventions described herein.

We claim:

1. A method of reducing toxic emissions from bituminous compositions, comprising the steps of:
providing an initial composition including coal tar, a coal tar emulsion, asphalt, or asphalt composition; and
adding a rheological modifier to the initial composition to form a reduced emission composition;
wherein the rheological modifier includes a tall oil saponified in an anhydrous strong base; and
wherein the reduced emission composition releases less toxic emissions into the atmosphere than the initial composition itself would otherwise release.

2. The method of claim 1, wherein the toxic emissions reduced by the reduced emission composition include polycyclic aromatic hydrocarbons (PAHs), or volatile organic compounds (VOCs).

3. The method of claim 2, wherein the polycyclic aromatic hydrocarbons include naphthalene, 2-methylinaphthalene, 1-methylinaphthalene, acenaphthylene, or acenaphthene.

4. The method of claim 2, wherein the polycyclic aromatic hydrocarbons include fluorene.

5. The method of claim 2, wherein the polycyclic aromatic hydrocarbons include phenanthrene, or phenanthrene.

6. The method of claim 2, wherein the polycyclic aromatic hydrocarbons include pyrene.

7. The method of claim 1, wherein the toxic emissions reduced by the reduced emission composition include carbon compounds.

8. The method of claim 1, wherein the toxic emissions are reduced by at least 15 percent.

9. The method of claim 1, wherein the anhydrous strong base is anhydrous sodium hydroxide.

10. The method of claim 1, further comprising spray drying the rheological modifier to form a powder with a water content of not more than 1 weight percent of the weight of the rheological modifier.

11. The method of claim 1, wherein the saponified tall oil is distilled.

12. The method of claim 1, wherein adding the rheological modifier includes adding an amount of rheological modifier representing about 1 weight percent or more of the weight of the initial composition.

13. The method of claim 1, wherein adding the rheological modifier includes adding an amount of rheological modifier representing about 3 weight percent or more of the weight of the initial composition.

14. The method of claim 13, wherein the toxic emissions are reduced by at least 15 percent.

15. The method of claim 1, further comprising applying the reduced emission composition to a roadway.

16. A reduced emission composition for reducing toxic emissions that would otherwise occur in bituminous compositions, comprising:
an initial composition including coal tar, a coal tar emulsion, or asphalt; and
a chemical rheological modifier including a tall oil saponified in an anhydrous strong base.

17. The reduced emission composition of claim 16, wherein the anhydrous strong base is an anhydrous sodium hydroxide.

18. The reduced emission composition of claim 16, wherein the saponified tall oil is distilled.

19. The reduced emission composition of claim 16, wherein the chemical rheological modifier comprises about 1 weight percent or more of the weight of the initial composition.

20. The reduced emission composition of claim 16, wherein:
the toxic emissions reduced include one or more of polycyclic aromatic hydrocarbons (PAHs), volatile organic compounds (VOCs), carcinogens, and carbon compounds; and
the reduced emission composition emits at least 15 percent less toxic emissions than the initial composition.
